(19) United States
(12) Patent Application Publication
(10) Pub. No.: US 2023/0401624 A1
(43) Pub. Date: Dec. 14, 2023

(54) RECOMMENDATION ENGINE GENERATION

(71) Applicant: Chubb INA Holdings, Inc., Philadelphia, PA (US)

(72) Inventor: Rupak Bose, Fanwood, NJ (US)

(21) Appl. No.: 17/828,094

(22) Filed: May 31, 2022

(51) Int. Cl. G06Q 30/06; G06N 5/02

(52) U.S. Cl. CPC G06Q 30/0631; G06N 5/022

(57) ABSTRACT

Methods, systems, and apparatus, including computer programs encoded on computer storage media, for generating a recommendation engine. One of the methods includes receiving, from a plurality of data sources, input data; generating, using each of two or more propensity models, output data by providing training data from the input data to the respective propensity model; determining, for each of the propensity models, a first accuracy of the respective propensity model using the respective output data; determining, for each of the two or more propensity models, a second accuracy of the respective propensity model using testing data from the input data; selecting, using the first accuracies and the second accuracies for the two or more propensity models, a propensity model from the two or more propensity models; and providing, to a system, the selected propensity model to enable the system to generate a recommendation using the selected propensity model.

### BACKGROUND

Systems can use recommendation tools to automatically generate recommendations given various inputs. Some training systems can train or otherwise generate recommendation tools using training data.

### SUMMARY

In general, one aspect of the subject matter described in this specification can be embodied in methods that include the actions of receiving, from a plurality of data sources, input data; generating, using each of two or more propensity models, output data by providing training data from the input data to the respective propensity model; determining, for each of the two or more propensity models, a first accuracy of the respective propensity model using the respective output data; determining, for each of the two or more propensity models, a second accuracy of the respective propensity model using testing data from the input data; selecting, using the first accuracies and the second accuracies for the two or more propensity models, a propensity model from the two or more propensity models; and providing, to a system, the selected propensity model to enable the system to generate a recommendation using the selected propensity model.

In general, one aspect of the subject matter described in this specification can be embodied in methods that include the actions of receiving, from a plurality of data sources, input data that includes, for each of multiple records, a) a plurality of parameters, and b) values for at least some of the parameters; determining, for the plurality of parameters, whether characteristics of the corresponding parameter in the multiple records satisfy one or more propensity modeling thresholds; selecting, using the parameters that satisfy the one or more propensity modeling thresholds, a propensity model from two or more propensity models; and providing, to a system, the selected propensity model to enable the system to generate a recommendation using the selected propensity model.

Other embodiments of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. Selecting the propensity model can include: determining, for each of the two or more propensity models, a difference between the respective first accuracy and the respective second accuracy; determining, for each of the two or more propensity models, whether the respective difference satisfies a difference threshold; and selecting, from the two or more propensity models, the propensity model using a result of the determination whether the respective differences satisfy the difference threshold. Selecting the propensity model can include selecting, from the two or more propensity models, a propensity model that has a respective difference that satisfies the difference threshold. Selecting the propensity model can include selecting, from the two or more propensity models, a propensity model that a) has a respective difference that satisfies the difference threshold and b) has a first accuracy that satisfies an accuracy threshold.

In some implementations, selecting the propensity model can include selecting, from the two or more propensity models, a propensity model that has a first accuracy that satisfies an accuracy threshold. The testing data can include different data from the input data.

In some implementations, receiving the input data can include receiving input data that includes one or more parameter types. Providing the selected propensity model can include providing the selected propensity model to enable the system to generate the system to generate a recommendation using the selected propensity model and second input data that includes values for at least some of the one or more parameter types. The method can include determining, for at least some of the one or more parameter types, whether a percentage of the multiple records that include a corresponding value for the corresponding parameter type satisfies a percentage threshold; determining, for at least some of the one or more parameter types, whether the parameter type can be used for propensity modeling; and determining, for at least some pairs of parameter types from of the one or more parameter types, whether the corresponding pair of parameters is correlated; or determining, for at least some of the one or more parameter types, whether the corresponding parameter type is predictive of the recommendation.

In some implementations, determining, for the plurality of parameters, whether characteristics of the corresponding parameter in the multiple records satisfy the one or more propensity modeling thresholds can include: determining, for at least some of the plurality of parameters, whether a percentage of the multiple records that include a corresponding value for the corresponding parameter satisfies a percentage threshold; determining, for at least some of the plurality of parameters, whether a type of the corresponding parameter can be used for propensity modeling; and determining, for at least some pairs of parameters from of the plurality of parameters, whether the corresponding pair of parameters is correlated; or determining, for at least some of the plurality of parameters, whether the corresponding parameter is predictive of the recommendation. The method can include transforming, for at least one of the parameters i) that does not satisfy at least of the one or more propensity modeling thresholds and ii) has a first parameter type, the corresponding parameter to a second parameter with a second, different parameter type that satisfies the one or more propensity modeling thresholds.

In some implementations, the method can include receiving, from the plurality of data sources, second input data that includes, for each of multiple second records, a) a second plurality of parameters, and b) second values for at least some of the second parameters; determining, for the second plurality of parameters, whether characteristics of the corresponding second parameter in the multiple second records satisfy the one or more propensity modeling thresholds; in response to determining that the characteristics of at least some of the second plurality of parameters do not satisfy the one or more propensity modeling thresholds, selecting a collaborative filtering model; and providing, to another system, the collaborative filtering model to enable the other system to generate a second recommendation using the collaborative filtering model and third input data that includes the second plurality of parameters and corresponding values for at least some of the second plurality of parameters. Receiving the input data can include receiving input data that includes the plurality of parameters, each parameter of which has a corresponding parameter type. Selecting the propensity model can include selecting, from the two or more propensity models, the propensity model that is mapped to the parameter types for which the input data has corresponding values.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various embodiments and may result in one or more of the following advantages. Selecting a particular propensity model using its accuracy, its repeatability, or both, can lead to more accurate and repeatable results for given input data. The ability of the disclosed propensity models to cross-examine the likelihoods of different events can provide nuanced results when more than one event impacts a decision.

Due to its ability to preprocess data and choose the best-suited propensity model among the multiple propensity models, the systems and methods described in this specification can deliver results to analysts with little statistical knowledge. Additionally, the disclosed systems and methods can provide recommendations relatively quickly, e.g., in less than an hour, compared to the time it normally takes an analyst to build a model, e.g. multiple days.

The preprocessing engine can transform data that would otherwise be unusable or detrimental to a propensity, collaborative, or both, model, leading to more accurate and repeatable results. By introducing a propensity modeling threshold, the model training system can choose between propensity modeling and collaborative filtering to provide better recommendations compared to other systems.

In some implementations, the systems and methods described in this specification can create a deployment code package for a model that can be deployed in multiple different systems. For instance, the systems can generate a Python deployment code package that can be deployed on multiple different systems, e.g., with different operating systems, all of which have corresponding Python environments.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a model training system selects a model using one or more thresholds, multiple accuracies, or both.

FIG. 2 is a flow diagram of an example process for providing a selected model.

FIG. 3 is a block diagram of a computing system that can be used in connection with computer-implemented methods described in this specification.

Like reference numbers and designations in the various drawings indicate like elements.

### DETAILED DESCRIPTION

Building recommendation tools from scratch can be an expensive and timely undertaking, even with trained analysts. Before training can begin, analysts make decisions about what type of data to include, the quality of the data, and what to do with data in different or inconvenient formats. Analysts might also need to decide between what types of models to use, depending on the objective for the recommendation tool. Understanding how to combine the results of different models, for example modeling the likelihood for an event to happen versus the likely duration of an event, can be difficult.

To improve the accuracy of a recommendation tool, the generation of the recommendation tool, or both, a model training system can use the types of input parameters in the training data to select a model from multiple models, select a type of model, or both. The model training system can select a model that provides reliable results with flexibility, ease, and speed. At least two types of models, a propensity model and a collaborative filtering model, can be used in combination or separately. This training, selection, or both, process can reduce an amount of computer resources involved in selecting a model compared to other systems.

Before using either tool or a combination of the two, a preprocessing engine can prepare the data for training. Preprocessing data can be a time-consuming and nontrivial task for analysts. Businesses will often want to use data from multiple sources that come in different formats. To address this, the preprocessing engine can convert a portion of the data to a standard format. This can include converting file types from different file types to a single file type.

The model training system can analyze the preprocessed data to determine whether the data satisfies one or more propensity modeling thresholds. If so, the model training system can provide the preprocessed data to each of multiple propensity models to select one of the propensity models to use to generate recommendations given the type of the data.

The model training system can calculate an associated accuracy and repeatability for each propensity model, each with its own algorithm. A ranking system that follows certain rules can choose the best propensity model using the accuracy, repeatability, or both of each propensity model. Each propensity model can predict two or more values associated with a likelihood associated with an event. Each propensity model can also cross-examine two likelihoods associated with different types of events.

If the data does not satisfy the one or more propensity modeling thresholds, the model training system can select a collaborative filtering model to use to generate recommendations given the type of the data. For instance, this may occur when an amount of the data does not satisfy an amount threshold, when the types of the data do not satisfy one or more data type criteria, or both.

The model training system can then use the selected model. For instance, the model training system can generate a recommendation using the selected model, provide the selected model to another system for use generating a recommendation, or both.

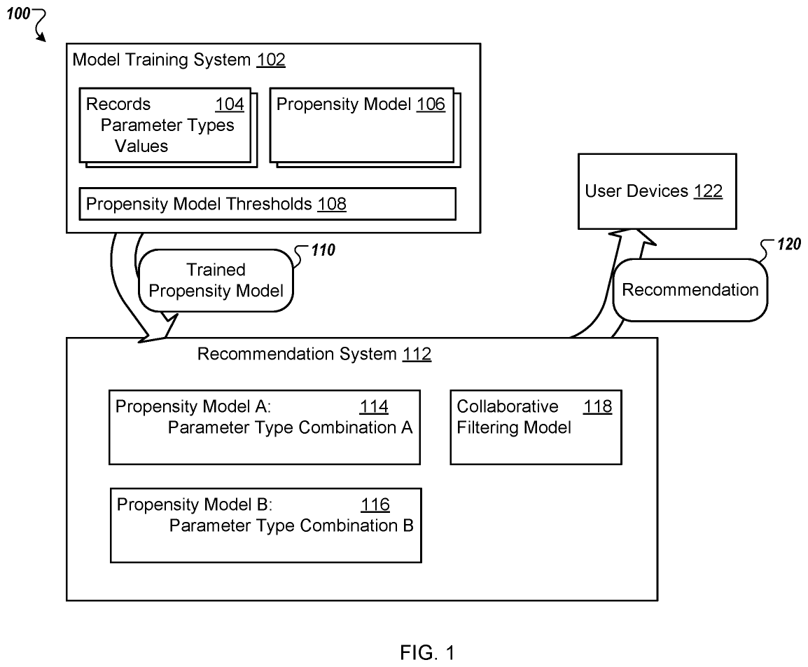

FIG. 1 depicts an example environment 100 in which a model training system 102 selects a model using one or more thresholds, multiple accuracies, or both. The model training system 102 can select a model for a combination of input parameter types. A recommendation system 112 can use the selected model to generate one or more recommendations 120 given a particular set of values for the combination of input parameter types.

For instance, the model training system 102 can receive input data 104, which can include records. The records can include parameters, parameter types, and values. For example, the input data 104 can include health records associated with multiple people, security data for analysis, or other appropriate data. An individual health record can include one or more parameter types. For example, a health record can include parameter types such as age or weight, which could have corresponding values of the age or weight stored as a number. A health record can include parameter types such as free-form text descriptions of symptoms written for a patient, which can have a parameter type different from that used to store the values of age or weight. In some examples, multiple health records in the input data 104 can have the same format, e.g. include the same parameter types. In some examples, multiple health records in the input data 104 can have different formats, e.g. include different parameter types.

In some examples, the input data 104 can have missing or invalid entries, which can correspond to a parameter type not having an assigned a value in a record. In some examples, a value exists for each parameter type in a record. In some examples, values exist for at least some of the parameters. When at least a threshold amount of the parameter types lack values, a system, e.g., that implements a machine learning model, can struggle to produce an accurate and repeatable model. Generally, machine learning models learn from patterns in data sets. When an insufficient amount of data is available, e.g., values are missing, or when data in different records essentially represents the same parameter, but is labeled as different parameter types, a system might be unable to take full advantage of the patterns in the input data. In some implementations, training a machine learning model with incomplete data sets or data sets with different formats can be less effective than training a machine learning algorithm with the subset of the data sets that has a value for every parameter type.

In some implementations, a preprocessing engine, e.g., included in the model training system 102, can convert data of multiple formats into a single format and transform data with missing or invalid entries into usable data. When input data 104 has been preprocessed, it becomes preprocessed data. Some examples of preprocessing can include rounding floating point numbers to integers or converting text documents with unformatted responses into a structured file format, e.g., a comma-separated values (CSV) file.

The model training system 102 stores multiple propensity models 106 in memory. The multiple propensity models 106 can include any appropriate number of propensity models greater than one, e.g., at least twelve different models.

Each of the models can use a different algorithm to analyze data, e.g., the input data 104 or the preprocessed data. Some example algorithms include logistic regression, decision trees, XGBoost, random forests, naive Bayes, quadratic vector, and other machine learning algorithms. In some implementations, a user can optionally choose the algorithm, as long as it is in a supported format.

The model training system 102 can process at least a portion of the input data 104 with the propensity models 106. For instance, the model training system 102 can provide a portion of the input data 104, e.g., the preprocessed data, to each of the propensity models 106 to cause the propensity models to generate corresponding output. The model training system 102 can consider the amount and types of records, parameter types, and values available when determining how each propensity model 106 will perform given the input data 104.

The model training system 102 can receive, as output from the trained propensity models 106, recommended actions. The recommended actions can be recommendations of actions to perform given the portion of the input data 104 provided to any particular propensity model 106. For instance, the model training system 102 can provide the portion of the input data 104 to a first propensity model 106 and receive output from the first propensity model 106 that indicates a recommended action to perform given the portion of the input data 104 provided to the first propensity model 106. The recommended action can be any appropriate action, such as a recommendation to contact a person, recommend a particular service, or recommend a network security action to perform given the portion of the input data 104.

The model training system 102 can calculate, for each of the propensity models 106 that were provided a portion of the input data 104, an associated accuracy, an associated repeatability, or both. The percentage of records, from the input data 104 provided to a particular propensity model 106, for which the generated output of the particular propensity model 106 compares well with an expected output can indicate an accuracy for the particular propensity model 106. The comparison between the generated and expected output can depend on qualities of the recommendation provided by the particular propensity model 106, such as the type of action, e.g., contacting a person or changing a price, or which persons were associated with recommendations. If a particular propensity model 106 has a low accuracy, its accuracy can possibly be improved by training, which can involve updating the weights involved in the mathematical transformations to weights that are more likely to generate the expected output results. The portion of data used to achieve a higher accuracy for a given propensity model 106 can be called training data.

When the model training system 102 calculates the repeatability for each propensity model 106, it uses a portion of the input data different from the portion of the input data used to calculate the accuracy. The portion of the input data 104 used to calculate the accuracy of a propensity model 106 can be called training data. The portion of the input data 104 used to calculate the repeatability of a propensity model 106 can be called verification data.

For example, the model training system 102 can provide a portion of input other than the training data, e.g., the testing data, to each propensity model 106, whose weights can be fixed after training. The model training system 102 can determine a second accuracy of a particular propensity model 106 using the verification data. The second accuracy can indicate a degree to which the particular propensity model 106 accurately generates output data, e.g., a recommendation, given the verification data used as input to the particular propensity model without updating any of the weights of the particular propensity model 106 using the output. If the second accuracy for the particular propensity model 106 is high, e.g., satisfies a threshold value, that propensity model 106 has a high repeatability. If the second accuracy for the particular propensity model 106 is low, e.g., does not satisfy the threshold value, that propensity model 106 has a low repeatability. In general, the repeatability can measure how much the second accuracy of the particular propensity model 106 changes with different portions of the input data 104, which data was not used during the training process.

The model training system 102 can select a propensity model from the propensity models 106 using the accuracy, repeatability, or both. The selection can be of a model to use for generating recommendations given the input data 104 used to determine the accuracy, the repeatability, or both, given the parameter types, parameter values, or both, or a combination of these. For example, the model training system 102 can compare propensity model thresholds 108 to the calculated accuracy, repeatability, or both.

The model training system 102 can use a ranking engine that follows predetermined rules can select the best model using its respective accuracy, repeatability, or both.

In some implementations model training system 102 can determine the accuracy using a parabolic curve. The value of area under the parabolic curve (AUC) can indicate

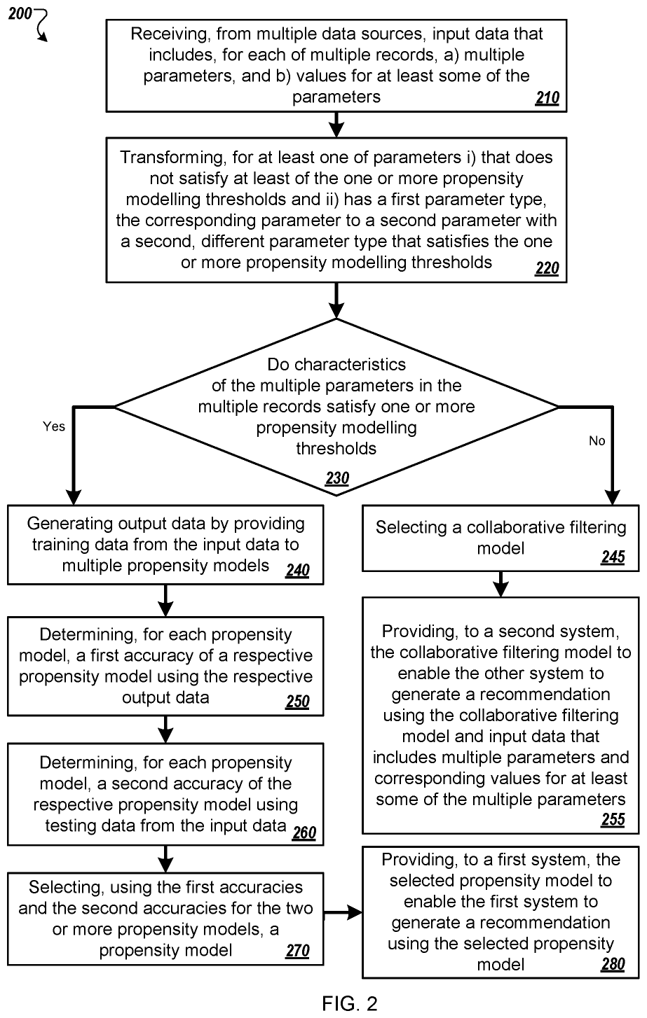

By training the propensity models 106 with portions of the input data, e.g., training data, the model training system 102 maps input data parameters to trained models to determine which trained model best predicts corresponding output data. The model training system 102 can select the best propensity model 106 using the ranking engine. The ranking engine can use one or more rules to select the best propensity model, as described in more detail below with reference to FIG. 2. The model training system 102 can send a trained version of the selected propensity model, e.g., the trained propensity model 110, to the recommendation system 112.

In some implementations, the model training system 102, e.g., the ranking engine, can select more than one propensity model, e.g., Propensity Models A-B 114 and 116. For instance, during training, the model training system 102 can train combinations of the propensity models 106 to generate output, can select two trained propensity models 106 given the corresponding output from the models, or both. For example, each Propensity Model A-B 114 and 116 can use a different combinations of parameter types in the input data 104 during training. In some implementations, certain propensity models can achieve higher accuracy and repeatability scores with certain types of parameters. As a result, the model training system 102 can select multiple propensity models 106 that use different parameter types as input. Propensity Model A 114 can predict the likelihood of a certain event to occur, and Propensity Model B 116 can predict the frequency of a certain class of events occurring.

By combining the two or more models, the model training system 102 can train the combined models to more accurately generate recommendations compared to the model training system 102, or the recommendation system 112, using either of the models alone. In some examples, by combining two or more models, the model training system 102 can select a combination of propensity models that generate detailed recommendations than otherwise might be generated. For instance, the combined models can generate multiple output values when any particular model used alone would only generate a single output value.

The model training system 102 can train, provide, or both, at least three types of propensity models. For example, the models can include Propensity Model A 114, Propensity Model B 116, and a combined model that combines Propensity Model A 114 and Propensity Model B 116, such as a holistic acquisition logic (HAL) model. In some implementations, the Propensity Model A 114 can measure the likelihood a given person to make a purchase, and Propensity Model B 116 can measure the likelihood of person to repeatedly make purchases. Although both of these models can be useful alone, correlating the results of both models can lead to more informed decisions.

The combined model can create a matrix, with each axis measuring the respective likelihoods generated by Propensity Models A-B 114 and 116. This matrix can represent a two-dimensional space, which can provide more nuance in output results than a one-dimensional output result. For example, Propensity Model A 114 can generate an output that indicates a propensity of a person, for which input data was provided to the Propensity Model A 114, to buying initially. Propensity model B 116 can generate an output that indicates a propensity of the person, for which input data was provided to the Propensity Model B 116, to staying active after six months. The combined matrix for the two Propensity Models A-B 114-116 can provide combination of the outputs of the two Propensity Models A-B 114-116, provide more accurate classifications, e.g., finer customer definitions, or both, compared to either model alone or other systems. Some examples of finer customer definitions can include, i) customers who have high propensity to buy and staying active, ii) customers who have higher propensity to buy but are less likely to stay active after six months, or iii) customers who have lower propensity to buy but when they buy they are highly likely to staying active for more than a time period, e.g., more than six months.

By generating more accurate classifications for a set of input data, e.g., representing a person, the recommendation system 112, the user devices 122, or both, can more accurately determine how to allocate resources for the input data. For instance, the recommendation system 112 can provide more accurate classifications, e.g., finer definitions, that enable more precise business strategies for different customers with different classifications, e.g., customers who lower propensity to buy but highly likely to staying active after six months can be shifted to a lower cost marketing channel.

In some implementations, the recommendation system 112, the user devices 122, or both, can use the combined model to determine whether to even expend resources given a set of input data. For example, the combined model can generate a recommendation to skip providing data to persons who are neither likely to purchase a specific product nor purchase products in general.

In some implementations, the HAL model can generate customized recommendations. For instance, the HAL model can generate a recommendation for presentation, on a device of regularly purchasing persons who are not likely to purchase a specific product might, of an alternate advertisement that costs less to the business. For infrequent customers who are likely to be interested in a particular product, the HAL model might generate a recommendation that an infrequent customer be given a promotion for a lower price.

The model training system 102 can provide a selected propensity model 106 to a recommendation system 112. For instance, the model training system 102 can receive a request from the recommendation system 112 for a propensity model 106. The request can include the input data 104. The model training system 102 can use the input data 104, or a portion of the input data 104, to train the propensity models 106, select a propensity model 106, or both. The model training system 102 can provide a propensity model 106 to the recommendation system 112 given the input data 104, e.g., the parameter types, values, or both, included in the input data 104.

As a result, the model training system 102 can provide propensity models 106 to the recommendation system 112 for different parameter type combinations. The model training system 102 can provide a propensity model A 114 to the recommendation system 112 for a combination of parameter types A and can provide a propensity model B 116 to the recommendation system 112 for a combination of parameter types B. The propensity model A 114 can be the same type of propensity model, or a different type of propensity model as the propensity model B 116 when the combination of parameter types A is different from the combination of parameter types B.

The recommendation system 112, the model training system 102, or both, can include models other than propensity models. In some implementations, such as when the number of parameters types does not satisfy a propensity model threshold 108, the recommendation system 112 can receive, use, or both, a collaborative filtering model 118 for some parameter type combination. Whether propensity modeling is appropriate can depend on if certain kinds of data are available, such as whether or not an event to be modeled has happened before, an amount of input data 104 available, parameter types of the input data, the number of parameter types of the input data, or a combination of these. Some implementations of the recommendation system 112 include a collaborative filtering model 118, which may be more appropriate when the characteristics of one or more parameter types and one or more records in the input data 104 do not satisfy one or more propensity modeling thresholds.

In some implementations, the recommendation system 112 can select a collaborative filtering model 118. A collaborative filtering model 118 can identify entities with similar characteristics in the input data 104. For example, input data 104 can include a spreadsheet with a row for every entity in multiple columns representing information about that entity. Entities with similar characteristics in some columns, but not in others, can be identified by the collaborative filtering model 118. The collaborative filtering model 118 can use correlations that entities with similar characteristics will sometimes behave similarly when presented with the same options. For example, if one entity with similar characteristics, e.g., person A, has purchased a specific product, the collaborative filtering model 118 may recommend to present the other entities with similar characteristics, e.g., person B, with the option to purchase the same specific product in person B has not already purchased that product.

The collaborative filtering model 118 can utilize input data 104 from various sources when generating recommendations. The input data 104 provided to the collaborative filtering model 118 can include training data, e.g., when the model training system 102 trains the collaborative filtering model 118 given a particular combination of parameter types in the input data 104. In some examples, the collaborative filtering model 118 can use at least a portion of the input data 104 during runtime. For example, the recommendation system 112 can identify entities with similar characteristics within one business' product range or between more than one businesses' product ranges. Consequently, collaborative filtering can provide recommendations 120 even when the input data 104 does not satisfy the propensity model thresholds 108.

The recommendation system 112 can provide a recommendation 120 to a user device 122. In some implementations, the providing is in response to a request for a recommendation for a particular person; that includes a combination of parameter types and corresponding values, e.g., similar to or as same as that from the input data 104 used during training; or other characteristics of the request. In some implementations, a user makes a request, requests are automatically generated, or a combination of both. The recommendation 120 can include the output of the various propensity and collaborative filtering models. The recommendation system 112 can provide recommendations using the selected trained propensity model 110.

For instance, the recommendation system 112 can receive a request that includes a combination of multiple values each of which has a corresponding parameter type. The recommendation system 112 can analyze a mapping of propensity models to parameter combinations stored in memory. The recommendation system 112 can select, using the mapping, the propensity model that best matches the received request. The recommendation system 112 can select, as the best matching propensity model, a propensity model that has the same parameter type combination as the parameter types included in the request. When there is not an exact match of parameter type combinations, the recommendation system 112 can select, as the best matching propensity model, the propensity model that has the most parameter types that match those included in the request. The recommendation system 112 can use any appropriate process to select the best matching propensity model.

In some implementations, the model training system 102, the recommendation system 112, or both, can optimize a model for deployment on another device or system. For instance, when the model training system 102 trains models for use by multiple different recommendation systems 112 with different operating environments, e.g., different operating systems, the model training system 102 can create a deployment code package that enables use of a model on any of the multiple different recommendation systems 112 with different operating environments. As part of this deployment code package creation, the system can convert one or more portions of a model equation, representing the model, into code that can be executed on any of the different operating environments. For example, the model training system can convert any variables from a model equation into code, e.g., Python code, that can be executed on any of the different operating environments.

In some examples, the model training system 102 and the recommendation system 112 can be part of the same system. For instance, the model training system 102 and the recommendation system 112 can both be implemented on a cloud computing system.

The environment 100 is an example of a system implemented as computer programs on one or more computers in one or more locations, in which the systems, components, and techniques described in this specification are implemented. The user devices 122 can include personal computers, mobile communication devices, and other devices that can send and receive data over a network. The network (not shown), such as a local area network (“LAN”), wide area network (“WAN”), the Internet, or a combination thereof, connects the user devices 122, the model training system 102, and the recommendation system 112. The model training system 102 and the recommendation system 112 can use a single server computer or multiple server computers operating in conjunction with one another, including, for example, a set of remote computers deployed as a cloud computing service.

The environment 100 can include several different functional components that can include one or more data processing apparatuses, can be implemented in code, or both. Some examples of the functional components can include the preprocessing engine, the ranking engine, or both.

The various functional components of the environment 100 can be installed on one or more computers as separate functional components or as different modules of a same functional component. For example, the systems 102 and 112 of the environment 100, the various components included in the systems 102 and 112, or a combination of both, can be implemented as computer programs installed on one or more computers in one or more locations that are coupled to each through a network. In cloud-based systems for example, these components can be implemented by individual computing nodes of a distributed computing system.

FIG. 2 is a flow diagram of an example process 200 for providing a recommendation. For example, the process 200 can be performed by the model training system 102 and the recommendation system 112 from the environment 100.

A model training system can receive input data from multiple sources (210). The input data can include multiple records that each include multiple parameter types, and values for at least some of the parameter types. Example data sources include spreadsheets, text documents, surveys, and transcriptions. Parameter types can include an anonymized identifier for an entity, age, geographic location, and an events history associated with the entity. In some implementations, the entity is a person.

The model training system can transform, for at least one of parameters that does not satisfy at least of the one or more propensity modeling thresholds and has a first parameter type, the corresponding parameter to a second parameter with a second, different parameter type that satisfies the one or more propensity modeling thresholds (220). In some implementations, step 220 can be part of a preprocessing step.

Preprocessing can identify data that is unsuitable for modeling. For example, spreadsheets with missing entries or repeated entries can pose a problem. If data is found to be unsuitable for modeling, the model training system can reject the data from the data set.

The model training system can determine whether or not characteristics of the multiple parameters in the multiple records satisfy one or more propensity modeling threshold (230). This determination can include comparing propensity model thresholds to values from the input data, parameter types for the input data, or both.

The model training system can generate output data by providing training data from the input data to the multiple propensity models (240). The model training system can perform this step in response to determining that the characteristics of the multiple parameters in the multiple records satisfy one or more propensity modeling threshold.

For example, a subset of the input data can be used as training data. By using a subset of data and knowledge of the parameter types of the input data, the model training system can make more accuracy predictions about the performance of each propensity model. Before the model training system can generate output data, e.g., as part of a training process for at least some of the propensity models, the model training system can determine whether the input data, or the subset of the input data, is appropriate for training. The model training system can use the propensity modeling thresholds to determine whether the input data or the subset of the input data is appropriate for training.

For each propensity model, the model training system can determine a first accuracy of a respective propensity model using the respective output data (250). This first accuracy can be associated with the strength of the prediction, e.g., the likelihood of the propensity model to correctly predict a result. In some examples, the model training system can determine the first accuracy for each trained propensity model, e.g., when the model training system trains a subset of multiple propensity models.

For each propensity model, the model training system can determine a second accuracy of the respective propensity model using testing data from the input data (260). The second accuracy can be associated with the repeatability of the prediction, e.g., the likelihood of the propensity model to output a correct result given input data that was not used to train the propensity model. In some implementations, the testing data includes different data from the input data. In some examples, the model training system can determine the second accuracy for each trained propensity model, e.g., when the model training system trains a subset of multiple propensity models. The first accuracy, e.g., an accuracy score; the second accuracy, e.g., a repeatability score; or both, can be represented by a percentage between 0-100%, inclusive, a fraction, or another quantification.

Using the first and second accuracies for the multiple propensity models, the model training system can select a propensity model (270). The selection can be based on a weighted average of the two accuracies, a ranking system with predetermined rules, one or both of the accuracies, or a combination of these. For instance, the model training system can select a propensity model using just one of the accuracies if the other accuracy meets a certain threshold. For example, if a subset of propensity models have a first accuracy greater than a threshold value, then the model training system can select the propensity model with the greatest second accuracy. Alternatively, low scores can signify accuracy, repeatability, or both.

In some implementations, the model training system can analyze the first accuracy first. When the first accuracy for multiple propensity models satisfies an accuracy threshold, the model training system can select the propensity model that has a second accuracy that satisfies a repeatability threshold. The repeatability threshold can indicate that the second accuracy should be the highest accuracy. In some examples, the repeatability threshold can indicate that the second accuracy should be the second accuracy that has the smallest difference from the corresponding first accuracy for the corresponding propensity model.

When none of the first accuracies satisfies the accuracy threshold, the model training system can select the propensity model that has a second accuracy that satisfies the repeatability threshold. An accuracy can satisfy a corresponding threshold when the accuracy is greater than, or greater than or equal to, the corresponding threshold. An accuracy can satisfy a corresponding threshold when the accuracy is within the corresponding threshold distance, e.g., from a respective base value identified by the corresponding threshold. An accuracy can satisfy a corresponding threshold when the accuracy otherwise satisfies all parameters required by the corresponding threshold, e.g., when the accuracy is the highest accuracy in instances when the corresponding threshold requires the highest accuracy.

The model training system can provide to a first system, e.g., the recommendation system, the selected propensity model, which enables the first system to generate a recommendation using the selected propensity model (280). The recommendation can include likelihoods of various events to occur and specific actions that can result in a favorable outcome. For example, in a propensity model directed to providing recommendations to devices for persons in a data set, the recommendations can include: present recommendation type A to person A and recommendation type B to person B,” “skip presenting a recommendation to person C,” or both.

If characteristics of the multiple parameters in the multiple records do not satisfy one or more propensity modeling threshold, the model training can select a collaborative filtering model (245). The input data for the collaborative filtering model can be the same or different from the input data for the propensity model. When the input data is a second, different input data, the second input data can include, for each of multiple second records, second parameters, and b) second values for at least some of the second parameters.

The recommendation system can provide the collaborative filtering model to another system to generate a recommendation, using the collaborative filtering model and input data that includes multiple parameters and corresponding values for at least some of the multiple parameters (255). The propensity models and collaborative filtering models can run on different systems or the same system. The recommendation provided by the collaborative filtering model can be similar in structure to that provided by a propensity model. The recommendation provided by the collaborative filtering model can identify entities within the input data that are similar in several ways, but dissimilar in others. The recommendation can also include actions related to the dissimilarities between the identified entities. For example, if person A and person B are similar in every aspect besides one, the recommendation may include an action related to the dissimilar aspect.

In some implementations, the model training system can supply the selected propensity model in the collaborative filtering model to the same system in steps 255 and 280.

The order of steps in the process 200 described above is illustrative only can be performed in different orders. For example, the second accuracy may be determined before or at substantially the same time as the determination of the first accuracy.

In some implementations, the process 200 can include additional steps, fewer steps, or some of the steps can be divided into multiple steps. For example, sometimes all of the parameters or at least enough of the parameters satisfy the at least one or more propensity modeling threshold, and do not transform into different parameter types, e.g., the process 200 need not include step 220. In some implementations, the selection of a propensity model can use only one accuracy, e.g., the second accuracy. Consequently, only one of steps 250 and 260 is performed in some implementations.

In some implementations, selecting the propensity model (270) can include determining a difference between the first and second accuracies for each propensity model, and whether each difference between the first and second accuracies satisfies a difference threshold, e.g., as an example of a repeatability threshold. The selection of the propensity model can depend on the determination of whether each difference satisfies the difference threshold, whether the first accuracy satisfies an accuracy threshold, or both.

Selecting the propensity model (270) can include selecting, from the two or more propensity models, the propensity model that is mapped to the parameter types for which the input data has corresponding values.

Providing the selected propensity model (280) can include providing the selected propensity model to enable the system to generate a recommendation using the selected propensity model and second input data that includes values for at least some of the one or more parameter types from the input data.

In addition to or instead of step 220, preprocessing can include various other types of analysis. For example, the model training system can determine, for at least some of the one or more parameter types, whether a percentage of the multiple records that include a corresponding value for the corresponding parameter type satisfies a percentage threshold. In some implementations, this could correspond to identifying data that has missing or invalid entries. The model training system can determine, for at least some of the one or more parameter types, whether the parameter type can be used for propensity modeling. In some implementations, this could correspond to categorizing data into types that can or cannot be used to train certain models, such as numbers versus text. The model training system can determine, for at least some pairs of parameter types from of the one or more parameter types, whether the corresponding pair of parameters is correlated. In some types of machine learning algorithms, correlated data can negatively impact the accuracy of the results. The model training system can determine, for at least some of the one or more parameter types, whether the corresponding parameter type is predictive of the recommendation. In some implementations, a portion of the input data may not be predictive, e.g., be irrelevant, to the recommendations. One or more of the mentioned determination processes may be combined.

In some implementations, when the characteristics of the multiple parameters in the multiple records satisfy one or more propensity modeling threshold, both a collaborative filtering and propensity model can be selected, be provided to the same or different systems, and generate recommendations.

The recommendation system 112 can be used in any appropriate environment. For instance, the recommendation system 112 can provide recommendations 120 to the user devices 122 as part of a digital platform, e.g., a web based platform. In some examples, the recommendation system 112 can provide recommendations 120 via telemarketing, email, or an application. In some implementations, the recommendation system 112 can provide recommendations 112 for presentation to a user for face to face provision to a consumer.

In some implementations, different types of models can be used to provide different types of recommendations, predict different events, or a combination of both. For instance, the recommendation system 112 can use a propensity model, e.g., any of the propensity models 106, 114, 116, to predict any event. Some examples of events can include buying, submitting an insurance claim, opening an email, connecting a device to a network, or adjusting a setting on a network connected device. The recommendation system 112 can use a collaborative filtering model 118 to recommend a likely next best action to perform. The likely next best action to perform can include a likely item that a consumer will buy, a likely next video a consumer will watch, a likely device that a person should connect to the network, e.g., to improve network security, or a likely setting that a person should change on a network connected device, e.g., to improve network security.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a recommendation system, model training system, or both.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

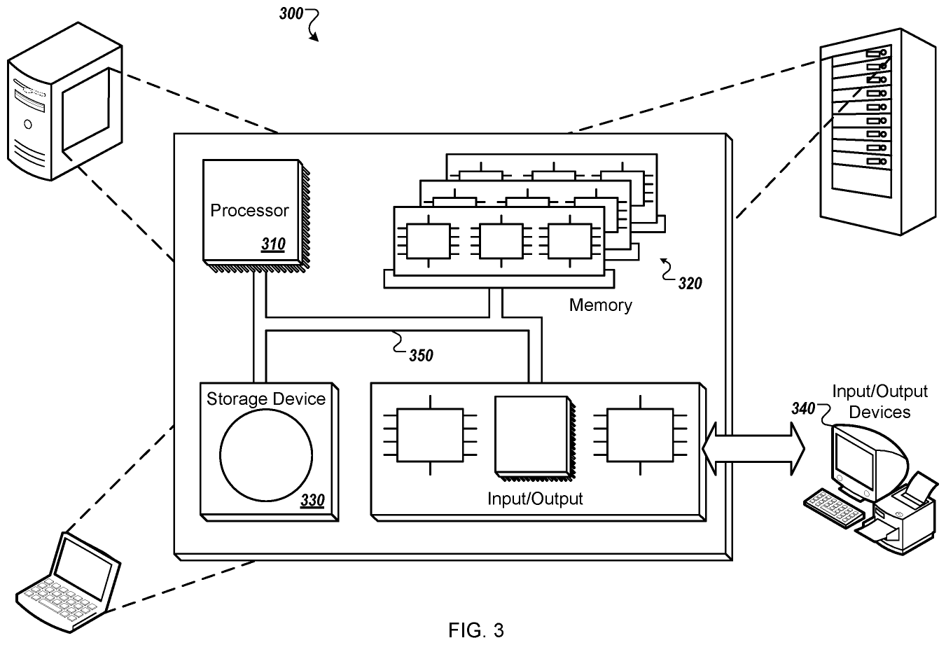

An example of one such type of computer is shown in FIG. 3, which shows a schematic diagram of a computer system 300. The system 300 can be used for the operations described in association with any of the computer-implemented methods described previously, according to one implementation. The system 300 includes a processor 310, a memory 320, a storage device 330, and an input/output device 340. Each of the components 310, 320, 330, and 340 are interconnected using a system bus 350. The processor 310 is capable of processing instructions for execution within the system 300. In one implementation, the processor 310 is a single-threaded processor. In another implementation, the processor 310 is a multi-threaded processor. The processor 310 is capable of processing instructions stored in the memory 320 or on the storage device 330 to display graphical information for a user interface on the input/output device 340.

The memory 320 stores information within the system 300. In one implementation, the memory 320 is a computer-readable medium. In one implementation, the memory 320 is a volatile memory unit. In another implementation, the memory 320 is a non-volatile memory unit.

The storage device 330 is capable of providing mass storage for the system 300. In one implementation, the storage device 330 is a computer-readable medium. In various different implementations, the storage device 330 may be a floppy disk device, a hard disk device, an optical disk device, or a tape device.

The input/output device 340 provides input/output operations for the system 300. In one implementation, the input/output device 340 includes a keyboard and/or pointing device. In another implementation, the input/output device 340 includes a display unit for displaying graphical user interfaces.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, comma-separated values (CSV), or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A system comprising one or more computers and one or more storage devices on which are stored instructions that are operable, when executed by the one or more computers, to cause the one or more computers to perform operations comprising:
receiving, from a plurality of data sources, input data;
generating, using each of two or more propensity models, output data by providing training data from the input data to the respective propensity model;
determining, for each of the two or more propensity models, a first accuracy of the respective propensity model using the respective output data;
determining, for each of the two or more propensity models, a second accuracy of the respective propensity model using testing data from the input data;
selecting, using the first accuracies and the second accuracies for the two or more propensity models, a propensity model from the two or more propensity models; and
providing, to a system, the selected propensity model to enable the system to generate a recommendation using the selected propensity model.

2. The system of claim 1, wherein selecting the propensity model comprises:
determining, for each of the two or more propensity models, a difference between the respective first accuracy and the respective second accuracy;
determining, for each of the two or more propensity models, whether the respective difference satisfies a difference threshold; and
selecting, from the two or more propensity models, the propensity model using a result of the determination whether the respective differences satisfy the difference threshold.

3. The system of claim 2, wherein selecting the propensity model comprises selecting, from the two or more propensity models, a propensity model that has a respective difference that satisfies the difference threshold.

4. The system of claim 2, wherein selecting the propensity model comprises selecting, from the two or more propensity models, a propensity model that a) has a respective difference that satisfies the difference threshold and b) has a first accuracy that satisfies an accuracy threshold.

5. The system of claim 1, wherein selecting the propensity model comprises selecting, from the two or more propensity models, a propensity model that has a first accuracy that satisfies an accuracy threshold.

6. The system of claim 1, wherein the testing data comprises different data from the input data.

7. The system of claim 1, wherein:
receiving the input data comprises receiving input data that includes one or more parameter types; and
providing the selected propensity model comprises providing the selected propensity model to enable the system to generate the system to generate a recommendation using the selected propensity model and second input data that includes values for at least some of the one or more parameter types.

8. The system of claim 7, the operations comprising:
determining, for at least some of the one or more parameter types, whether a percentage of the multiple records that include a corresponding value for the corresponding parameter type satisfies a percentage threshold;
determining, for at least some of the one or more parameter types, whether the parameter type can be used for propensity modeling; and
determining, for at least some pairs of parameter types from of the one or more parameter types, whether the corresponding pair of parameters is correlated; or determining, for at least some of the one or more parameter types, whether the corresponding parameter type is predictive of the recommendation.

9. A computer-implemented method comprising:
receiving, from a plurality of data sources, input data that includes, for each of multiple records, a) a plurality of parameters, and b) values for at least some of the parameters;
determining, for the plurality of parameters, whether characteristics of the corresponding parameter in the multiple records satisfy one or more propensity modeling thresholds;
selecting, using the parameters that satisfy the one or more propensity modeling thresholds, a propensity model from two or more propensity models; and
providing, to a system, the selected propensity model to enable the system to generate a recommendation using the selected propensity model.

10. The method of claim 9, wherein determining, for the plurality of parameters, whether characteristics of the corresponding parameter in the multiple records satisfy the one or more propensity modeling thresholds comprises:
determining, for at least some of the plurality of parameters, whether a percentage of the multiple records that include a corresponding value for the corresponding parameter satisfies a percentage threshold;
determining, for at least some of the plurality of parameters, whether a type of the corresponding parameter can be used for propensity modeling; and
determining, for at least some pairs of parameters from of the plurality of parameters, whether the corresponding pair of parameters is correlated; or
determining, for at least some of the plurality of parameters, whether the corresponding parameter is predictive of the recommendation.

11. The method of claim 9, comprising:
transforming, for at least one of the parameters i) that does not satisfy at least of the one or more propensity modeling thresholds and ii) has a first parameter type, the corresponding parameter to a second parameter with a second, different parameter type that satisfies the one or more propensity modeling thresholds.

12. The method of claim 9, comprising:
receiving, from the plurality of data sources, second input data that includes, for each of multiple second records, a) a second plurality of parameters, and b) second values for at least some of the second parameters;
determining, for the second plurality of parameters, whether characteristics of the corresponding second parameter in the multiple second records satisfy the one or more propensity modeling thresholds;
in response to determining that the characteristics of at least some of the second plurality of parameters do not satisfy the one or more propensity modeling thresholds, selecting a collaborative filtering model; and
providing, to another system, the collaborative filtering model to enable the other system to generate a second recommendation using the collaborative filtering model and third input data that includes the second plurality of parameters and corresponding values for at least some of the second plurality of parameters.

13. The method of claim 9, wherein:
receiving the input data comprises receiving input data that includes the plurality of parameters, each parameter of which has a corresponding parameter type; and
selecting the propensity model comprises selecting, from the two or more propensity models, the propensity model that is mapped to the parameter types for which the input data has corresponding values.

14. A non-transitory computer storage medium encoded with instructions that, when executed by one or more computers, cause the one or more computers to perform operations comprising:
receiving, from a plurality of data sources, input data;
generating, using each of two or more propensity models, output data by providing training data from the input data to the respective propensity model;
determining, for each of the two or more propensity models, a first accuracy of the respective propensity model using the respective output data;
determining, for each of the two or more propensity models, a second accuracy of the respective propensity model using testing data from the input data;
selecting, using the first accuracies and the second accuracies for the two or more propensity models, a propensity model from the two or more propensity models; and
providing, to a system, the selected propensity model to enable the system to generate a recommendation using the selected propensity model.

15. The computer storage medium of claim 14, wherein selecting the propensity model comprises:
determining, for each of the two or more propensity models, a difference between the respective first accuracy and the respective second accuracy;
determining, for each of the two or more propensity models, whether the respective difference satisfies a difference threshold; and
selecting, from the two or more propensity models, the propensity model using a result of the determination whether the respective differences satisfy the difference threshold.

16. The computer storage medium of claim 15, wherein selecting the propensity model comprises selecting, from the two or more propensity models, a propensity model that has a respective difference that satisfies the difference threshold.

17. The computer storage medium of claim 15, wherein selecting the propensity model comprises selecting, from the two or more propensity models, a propensity model that a) has a respective difference that satisfies the difference threshold and b) has a first accuracy that satisfies an accuracy threshold.

18. The computer storage medium of claim 14, wherein selecting the propensity model comprises selecting, from the two or more propensity models, a propensity model that has a first accuracy that satisfies an accuracy threshold.

19. The computer storage medium of claim 14, wherein the testing data comprises different data from the input data.

20. The computer storage medium of claim 14, wherein:
receiving the input data comprises receiving input data that includes one or more parameter types; and
providing the selected propensity model comprises providing the selected propensity model to enable the system to generate the system to generate a recommendation using the selected propensity model and second input data that includes values for at least some of the one or more parameter types.
